(19) United States
(12) Patent Application Publication
(10) Pub. No.: US 2024/0013096 A1
(43) Pub. Date: Jan. 11, 2024

(54) DUAL-MODEL MACHINE LEARNING FOR PROCESS CONTROL AND RULES CONTROLLER FOR MANUFACTURING EQUIPMENT

(71) Applicant: Liveline Technologies Inc., Livonia, MI (US)

(72) Inventors: Christopher Edward Couch, Ann Arbor, MI (US); John J. Burtenshaw, Tavistock (CA); Joseph Eugene Hernandez, Farmington Hills, MI (US); Andrew J. Cabush, Boiling Springs, SC (US); Sean G. Scott, Walled Lake, MI (US)

(21) Appl. No.: 18/300,632

(22) Filed: Apr. 14, 2023

Related U.S. Application Data
(60) Provisional application No. 63/391,065, filed on Jul. 21, 2022.
(60) Provisional application No. 63/359,526, filed on Jul. 8, 2022.

(51) Int. Cl. G06N 20/00

(52) U.S. Cl. CPC G06N 20/00

(57) ABSTRACT

A method includes training a machine learning model on a training data set, that describes input parameters to and corresponding output parameters from manufacturing equipment, using at least one learning algorithm to obtain a physics model that describes evolution of a state space of the manufacturing equipment, configuring a machine-learning-based controller agent to generate commands for the physics model that modify settings of a simulation of the manufacturing equipment by the physics model such that, responsive to input data, the physics model generates corresponding predicted output parameters, and training the machine-learning-based controller agent on the settings and corresponding predicted output parameters using at least one other learning algorithm. The configuring may include receiving at the machine-learning-based controller agent rules defining control actions for the manufacturing equipment to be taken responsive to a value of at least one output parameter from the manufacturing equipment being outside a predefined range.

### CROSS-REFERENCE TO RELATED APPLICATIONS

This application claims the benefit of provisional application Ser Nos. 63/359,526, filed Jul. 8, 2022, and 63/391,065, filed Jul. 21, 2022, the contents of which are incorporated in their entirety by reference herein.

### TECHNICAL FIELD

This disclosure relates to the control of manufacturing equipment.

### BACKGROUND

A manufacturing control system may respond to input signals and generate output signals that cause the equipment under control to operate in a particular manner.

### SUMMARY

A method includes receiving at a machine learning model a training data set describing input parameters to and corresponding output parameters from manufacturing equipment, training the machine learning model on the training data set using at least one learning algorithm to obtain a physics model that describes evolution of a state space of the manufacturing equipment, configuring a machine-learning-based controller agent to generate commands for the physics model that modify settings of a simulation of the manufacturing equipment by the physics model such that, responsive to input data, the physics model generates corresponding predicted output parameters, and training the machine-learning-based controller agent on the settings and corresponding predicted output parameters using at least one other learning algorithm such that, responsive to input data, the machine-learning-based controller agent maintains values of the predicted output parameters within respective predefined ranges.

The method my further include configuring the machine-learning-based controller agent to generate commands for the manufacturing equipment responsive to values of predicted output parameters from the physics model such that the manufacturing equipment executes the commands. The method may further include configuring the machine-learning-based controller agent to generate the commands for the manufacturing equipment responsive to input parameters to and corresponding output parameters from the manufacturing equipment. Configuring the machine-learning-based controller agent to generate commands for the physics model may include receiving at the machine-learning-based controller agent one or more rules defining control actions for the manufacturing equipment to be taken responsive to a value of at least one output parameter from the manufacturing equipment being outside a predefined range. The method may further include receiving machine-learning-based controller agent time series data describing operating states of the manufacturing equipment, and responsive to the operating states indicating the value of the at least one operating parameter is outside the predefined range, generating by the machine-learning-based controller agent a command for the manufacturing equipment to execute at least one of the control actions such that the manufacturing equipment performs the at least one of the control actions. The one or more rules may be obtained from a rules controller. The method may further include receiving machine-learning-based controller agent input modifying the one or more rules in real time. The settings may incorporate the rules. The method may include operating the manufacturing equipment with a rules controller to generate the training data set. The input parameters may include active control parameters, endogenous parameters, and exogenous parameters of the manufacturing equipment. The output parameters may include feature parameters of components produced by the manufacturing equipment. The physics model may be a sequence to sequence machine learning model. The sequence to sequence machine learning model may be an encoder-decoder model. The encoder-decoder model may include long short-term memory models. The at least one learning algorithm may be a supervised learning algorithm.

A method includes training a machine learning model on a training data set, that describes input parameters to and corresponding output parameters from manufacturing equipment, using at least one learning algorithm to obtain a physics model that describes evolution of a state space of the manufacturing equipment, configuring a machine-learning-based controller agent to generate commands for the physics model that modify settings of a simulation of the manufacturing equipment simulated by the physics model such that, responsive to input data, the physics model generates corresponding predicted output parameters, training the machine-learning-based controller agent on the settings and corresponding predicted outputs parameters using at least one other learning algorithm such that, responsive to input data, the machine-learning-based controller agent maintains values of the predicted output parameters within respective predefined ranges, and configuring the machine-learning-based controller agent to generate commands for the manufacturing equipment responsive to values of predicted output parameters from the physics model.

The configuring may include receiving at the machine-learning-based controller agent one or more rules defining control actions for the manufacturing equipment to be taken responsive to a value of at least one output parameter from the manufacturing equipment being outside a predefined range. The method may further include receiving machine-learning-based controller agent time series data describing operating states of the manufacturing equipment, and responsive to the operating states indicating the value of the at least one operating parameter is outside the predefined range, generating by the machine-learning-based controller agent a command for the manufacturing equipment to execute at least one of the control actions such that the manufacturing equipment performs the at least one of the control actions. The one or more rules may be obtained from a rules controller. The method may further include operating the manufacturing equipment with a rules controller to generate the training data set.

### BRIEF DESCRIPTION OF THE DRAWINGS

FIG. 1 is a block diagram of a manufacturing system.

FIGS. 2 and 3 are block diagrams of a control system.

FIG. 4 is a block diagram of the manufacturing and control systems of FIGS. 1, 2, and 3.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated or described with reference to any one example may be combined with features illustrated or described in one or more other examples to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Machinery used in mass production often has control parameters that impact the measurable characteristics of the resulting manufactured components. To illustrate a simple example, a stamping machine may apply a certain amount of pressure for a certain amount time to form metal into a desired shape. The ability of the stamping machine to repeatedly produce the same desired shape thus depends on this pressure and time. Through experience or otherwise, operators of the stamping machine may determine that certain ranges of values for pressure and time are acceptable for the stamping machine to produce parts having specified dimensions. If values of these control parameters change over time, a part made an hour earlier may have a slightly different shape than one made an hour later—resulting in less part-to-part consistency.

In this example, the actual pressure applied may be a function of the power supplied to the stamping machine for a given pressure setting. Variability in the power supplied may thus result in variability of the pressure applied even though the pressure setting does not change. Variability in the power supplied may thus be linked to variability in component shape—although with a time lag in between. That is, given the processing times associated with the stamping machine, a change in power supplied at time zero may manifest itself as a deviation from the desired shape at time 42 seconds. If it were possible to predict the impact a sudden change in power supplied would have on component shape at a later time, the pressure setting may be strategically altered to offset such changes. Specifically, if a reduction in power is experienced, the pressure setting may be correspondingly increased. If an increase in power is anticipated, the pressure setting may be correspondingly reduced, etc.

Statistical techniques, such as statistical process control, are commonly used to monitor and control manufacturing processes with the goal of producing more specification-conforming products with less waste. Within the context of complex manufacturing processes, these techniques may have a limit as to their effectiveness. Machinery used in mass production may have hundreds, if not thousands, of active control parameters (as well as endogenous parameters and exogenous parameters) that impact the measurable characteristics of the resulting manufactured components, which may number in the tens (e.g., 20). In this context, active control parameters are those parameters that are actively controlled and/or managed (e.g., speed setting, pressure setting, etc.), endogenous parameters are those parameters that manifest in the machinery but are not necessarily controlled (e.g., vibration of the machinery, temperature of the machinery, etc.), and exogenous parameters are those parameters associated with ambient conditions (e.g., humidity, ambient temperature, etc.) The ability to predict the impact active control parameter, endogenous parameter, and/or exogenous parameter change has on part measurable characteristics is thus a complex endeavor.

As explained in more detail below, supervised machine learning techniques in some examples may be used to establish a physics model that describes the input/output behaviors of the machinery. This physics model may then be used to train an intelligent (machine-learning-based) controller that will eventually oversee operation of the machinery in real time.

By way of brief review, supervised learning involves discovery of a function that maps an input to an output based on example input-output pairs. It infers the function from labeled training data that includes a set of training examples. Each example can be a pair defined by an input object (e.g., a vector) and a desired output value (the supervisory signal). The algorithm analyzes the training data and produces an inferred function, which can be used for mapping new examples. In optimal circumstances, the algorithm will correctly predict output values for unseen inputs. This may require the algorithm to generalize from the training data.

A number of supervised learning algorithms may be used to establish the physics model mentioned above including support-vector machines, linear regression, logistic regression, naive Bayes, linear discriminant analysis, decision trees, K-nearest neighbor, similarity learning, and neural networks. Certain examples herein consider neural networks, in particular recurrent neural networks, for the purpose of discussion. This discussion, however, generally applies to other learning techniques including supervised learning techniques.

In certain arrangements, control equipment for machinery may be programmed to automatically maintain control parameters within specified ranges. Continuing with the example above, a controller associated with the stamping machine may be programmed to monitor sensed values of pressure, temperature, and time, and responsive to any one of these values falling outside its corresponding specified range, the controller may take automatic action to drive the value back toward its specified range. If, for example, the specified range of temperature values is 80° C. to 85° C. and the sensed value of temperature exceeds that range and becomes 86° C., the controller may command heating elements of the stamping machine to reduce their temperature such that the sensed value returns to the 80° C. to 85° C. range. Likewise, if the specified range of pressure is 300 Pa to 325 Pa and the sensed value of pressure falls below that range and becomes 294 Pa, the controller may command pressure elements of the stamping machine to increase their pressure such that the sensed value returns to the 300 Pa to 325 Pa range. Sensed values and the output of the manufacturing process may drift due to natural variations in, for example, raw materials and environment. There are other sources of variation, such as equipment wear, etc., that may also contribute to this drift.

Time may pass between when sensed values and the output of the manufacturing process actually falls outside its desired range and when control equipment is alerted to such occurrence due to, for example, time lags associated with sensing equipment. Additional time may pass between when control equipment is alerted to such occurrence and when actions commanded by the control equipment drive the control parameter back within its specified range. During these durations of time, parts produced by the machinery may not have their specified dimensions or other characteristics.

We thus contemplate controllers and machine learning techniques that permit manufacturing equipment to anticipate that sensed values and the output of the manufacturing process will fall outside specified ranges, and to take corrective actions before they do so to maintain the control parameters within their specified ranges. This will avoid durations of time in which the control parameters are outside their specified ranges and thus durations of time during which a factory system may produce undesirable results (e.g., parts that do not have their desired dimensions or other characteristics).

In one example, a process expert uses an interface to describe to a rules controller which controlling inputs they would change to correct for circumstances in which a desired output or outputs deviate from their targets in a manufacturing process. Each pairing of desired output(s) and controlling input(s) is called a rule. Each output can have several rules that are used to keep it in specification and/or on target, each potentially with a different order of execution and mathematical weighting of importance (e.g., if dimensions of the manufactured components are too large, then an upstream cooling water valve must be opened and the temperature of the cooling water flowing from the valve must fall within some predefined range before a downstream cooling water valve is opened; parameter A can have a range from 0 to 2 with a target of 1, and parameter B can have a range from 0 to 10 with a target of 5, if A is weighted higher than B and conditions occur that prevent A and B from being at their targets, control operations would be performed to favor A closer to its target while B would be within its range but further away from its target). Within a rule, the process expert has several options: they can define a target value for each desired output; each desired output can be weighted differently, e.g., ranked with a level of importance; and/or they can define a proportional constant which is used in combination with the error function to apply correction to the controlling input. This expert advice can take the form of rules stored in a database. When the manufacturing process is running and producing outputs, software executing on a processor (e.g., the rules controller or engine) accesses the corresponding rules from the database and carries out the rules by pulling real time data from the process (i.e., the present values of the desired outputs). This automates the human decision making process and has several advantages: it removes human bias from the decision making process; it acts immediately upon seeing deviations in the desired output; and/or it removes the need for the human to make the correction.

In addition to the above, the rules that are created for automating the process can also accelerate the building of machine learning control models. This can be accomplished by extracting the rule parameters (e.g., controlling inputs and desired outputs) from the rules controller database and using them in machine learning training algorithms, thus reducing the amount of data required to make accurate predictions and corrections. The rule parameters, for example, could be used to configure a machine-learning-based controller agent to generate commands for a physics model that describes evolution of a state space of manufacturing equipment. The machine-learning based controller agent could then modify settings, which may thus incorporate the rule parameters, of the manufacturing equipment simulated by the physics model such that the physics model generates corresponding predicted output parameters. Moreover, operating manufacturing equipment subject to control of a rules controller for the purpose of creating data sets on which machine learning models can be trained can further introduce corresponding rule parameters to the machine learning models as such are implicitly expressed by the data sets.

By way of brief review, artificial neural networks that can be used to create machine learning control models may include four parts: nodes, activations, connections, and connection weights. Artificial neural networks are typically composed of many nodes. There are generally two kinds of network connections: input connections and output connections. An input connection is a conduit through which a node receives information and an output connection is a conduit through which a node sends information. A connection can be both an input connection and an output connection. When, for example, a connection is used to move information from a first node to a second node, the connection is an output connection to the first node and an input connection to the second node.

Recurrent neural networks, generally speaking, remember their input via internal memory, making them capable of handling sequential data, such as time series data indicating ambient conditions, control inputs to manufacturing equipment, and measurable characteristics of components produced by the manufacturing equipment. Because of this internal memory, recurrent neural networks can track information about inputs received and predict what is coming next: recurrent neural networks add the immediate past to the present. As such, recurrent neural networks have two inputs: the present and the recent past. Weights are applied to the current and previous inputs. These weights may be adjusted for gradient descent and backpropagation through time purposes. Moreover, the mapping from inputs to outputs need not be one-to-one.

Long short-term memory networks are an extension of recurrent neural networks. Long short-term memories permit recurrent neural networks to remember inputs over longer periods of time in a so-called memory, that can be read from, written to, and deleted. This memory can decide whether to store or delete information based on the importance assigned to the information. The importance of certain information may be learned by the long short-term memory over time. A typical long short-term memory has sigmoidal input, forget, and output gates. These determine whether to accept new input, delete it, or permit the new input to affect the current timestep output.

Sequence to sequence models can be constructed using recurrent neural networks. A common sequence to sequence architecture is the encoder-decoder architecture, which has two main components: an encoder and a decoder. The encoder and decoder can each be, for example, long short-term memory models. Other such models, however, are also contemplated. The encoder reads the input sequence and summarizes the information into internal state or context vectors. Outputs of the encoder are discarded while the internal states are preserved to assist the decoder in making accurate predictions.

The decoder's initial states are initialized to the final states of the encoder. That is, the internal state vector of the final cell of the encoder is input to the first cell of the decoder. With the initial states, the decoder may begin generating the output sequence.

The above and other concepts can be adapted to be used within the context of the manufacturing environment described above. In one example, long-short term encoder-decoder models, transformers (e.g., bidirectional encoder representations from transformers, generative pre-trained transformer 3s, etc.) may form the basis of a sequence to sequence model trained to interpret time series data describing ambient conditions and manufacturing operations, and predict corresponding component characteristics. The appropriate controllers can then take corrective actions before such happens to maintain the parameters within their specified ranges.

The time series data may include actual control parameter values (e.g., current, machine revolutions per minute, machine pressure, machine temperature, etc.), endogenous control parameter values (e.g., machine vibration, etc.), and exogenous parameter values (e.g., ambient temperature, humidity, etc.), changes in these values over predefined durations, and other related data, and may be pre-processed using various digital signal processing techniques (e.g., Fourier analysis, wavelet analysis, etc.) to generate a feature set describing evolution of a state space (the set of all possible configurations) of manufacturing equipment in the frequency and/or time domains. For a given application, the specific set of digital signal processing techniques can be determined using standard methodologies including simulation, trial and error, etc.

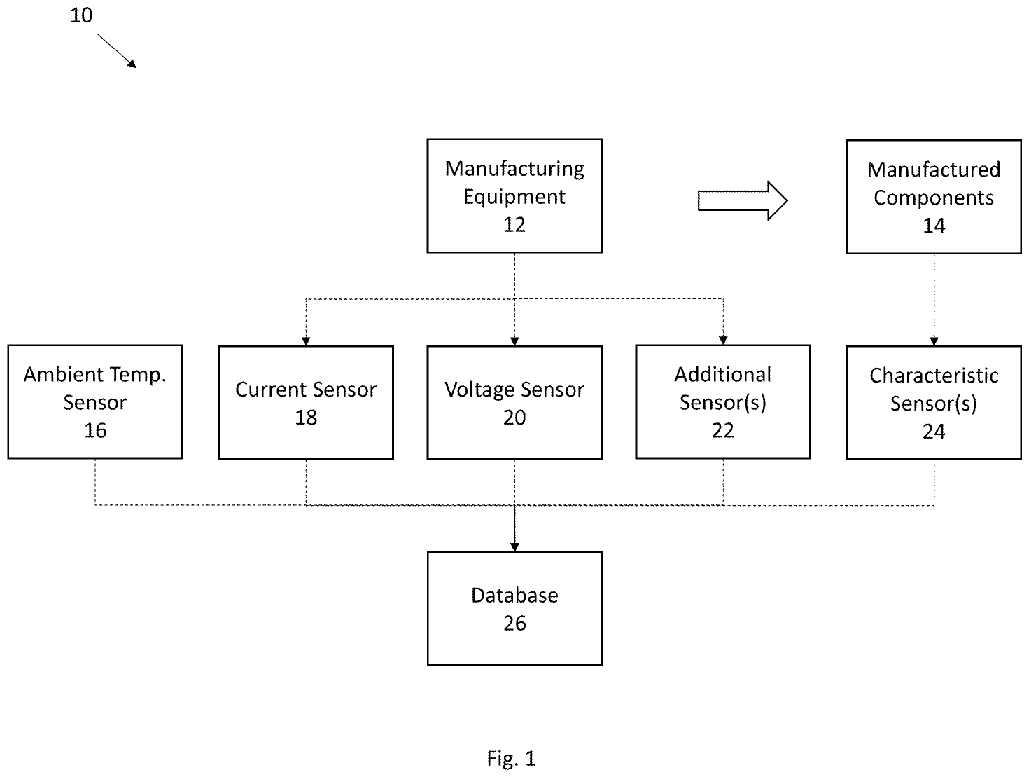

Referring to FIG. 1, an example manufacturing system 10 may include manufacturing equipment 12 (e.g., extruders, presses, stampers, etc.) that physically or virtually produces (e.g., assembles, creates, etc.) manufactured components 14 (e.g., tubing, panels, etc.). The manufacturing system 10 may also include one or more ambient condition (exogenous) sensors 16, current sensor 18, voltage sensor 20, one or more additional sensors 22, one or more characteristic sensors 24, and database 26. The ambient condition sensors 16 measure one or more ambient conditions (e.g., humidity, temperature, etc.) in a vicinity of the manufacturing equipment 12. The current and voltage sensors 18, 20 measure current and voltage supplied to the manufacturing equipment 12. The additional sensors 22 measure other active control and endogenous parameters of the manufacturing equipment 12. The characteristic sensors 24 measure various feature parameters (e.g., length, stiffness, thickness, etc.) of the manufactured components 14.

These sensed values may be reported to the database 26 sequentially. That is, at time to, each of the sensors 16, 18, 20, 22, 24 detects and reports their value to the database 26, at time ti, each of the sensors 16, 18, 20, 22, 24 detects and reports their value to the database 26, etc. The database 26 thus receives times series data describing ambient condition, endogenous, and control parameter values associated with operation of the manufactured equipment 12, and feature parameter values associated with the manufactured components 14 produced by the manufacturing equipment 12. Such an arrangement can be used to collect a vast amount of data for training purposes.

Various transformations (e.g., data cleansing, band pass filtering, convolutional operations, principal component analysis, wavelet transformation, etc.) on the time series data held in the database 26 can be performed to generate a streaming feature set spanning a relevant state space describing evolution of the manufacturing process associated with the manufacturing equipment 12. The relevant state space can be identified iteratively during model training and evaluation.

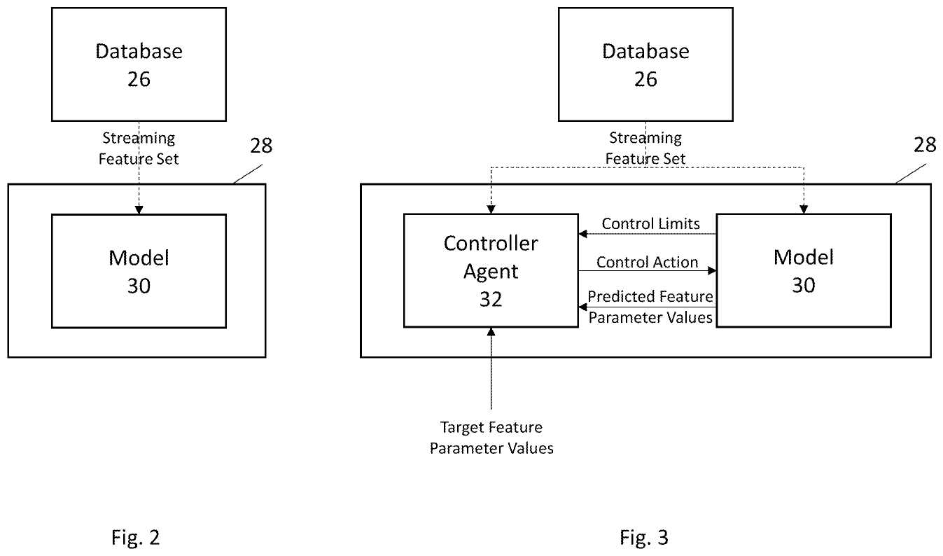

Referring to FIG. 2, one or more processors 28 may implement a long-short term encoder-decoder model 30 (or another appropriate model) trained on at least a portion of the streaming feature set from the database 26. 60 minutes, 600 minutes, or 6000 minutes, etc. of the streaming feature set, for example, can be used to train the long-short term encoder-decoder model 30 to recognize the relationships between sensed ambient conditions and endogenous and control parameter values of the sensors 16, 18, 20, 22 and resulting sensed feature parameter values of the characteristic sensors 24. Once properly trained, the model 30 (physics model) can predict future feature parameter values of the manufactured components 14 from the streaming feature set.

A pattern of certain ambient conditions and/or control parameter values may precede other control parameter values falling outside their specified ranges. As a simple example, the model 30 may recognize that pressure of the manufacturing equipment 12 (e.g., the stamping machine mentioned earlier) may begin to rise at a rate of 1 Pa per second when humidity is less than 30% and supply voltage to the manufacturing equipment 12 is greater than 225 V. If the pressure is currently 323 Pa and the specified range for the pressure is 300 Pa to 325 Pa, the pressure would presumably fall outside of its specified range within 3 seconds. As another example, if a measured dimension is increasing at some rate and will exceed its limit, action may be taken before the limit is reached. Actual scenarios may of course be more complicated with a pattern of hundreds or thousands of ambient and/or control parameter conditions preceding some control parameter value falling outside its specified range.

Referring to FIGS. 1 and 3, the one or more processors 28 may further implement a controller agent 32 trained on the model 30 and the streaming feature set from the database 26. Prior to training of the controller agent 32, the model 30 (or other source) may inform the controller agent 32 as to control limits for the manufacturing equipment 12, which can be simulated by the model 30. Control limits may include, for example, operating pressure ranges for presses (300 psi to 500 psi), operating temperature ranges for drying ovens (50° C. to 80° C.), etc. Moreover, the controller agent 32 may receive target feature parameter values (e.g., target length=3 cm, target stiffness=5 N/m, etc.) for the manufactured components 14. During training of the controller agent 32, the model 30 and controller agent 32 may each synchronously receive a same portion of the streaming feature set from the database 26 to simulate feedback from the sensors 16, 18, 20, 22, 24 during a manufacturing run. This allows the model 30 to generate predicted feature parameter values for simulated manufactured components and to report those to the controller agent 32. The controller agent 32 may then direct control actions to the model 30 to change control settings within the control limits. In a first iteration and assuming an operating pressure of a press simulated by the model 30 is at 310 psi and an operating temperature of a drying oven simulated by the model 30 is 62° C., the controller agent 32 may increase one by some amount and decrease the other by some other amount, and learn what effect such changes have on the predicted feature parameter values from the model 30 relative to the target feature parameter values. The amounts of change may be arbitrary or governed by predetermined rules. The controller agent 32 may perform thousands, if not millions, of such iterations in a relatively short time to train itself using one or more learning algorithms on how control settings for the manufacturing equipment 12 can be changed to maintain the predicted feature parameter values, and thus actual feature parameter values, at or near the target feature parameter values as values from the sensors 16, 18, 20, 22, 24 change.

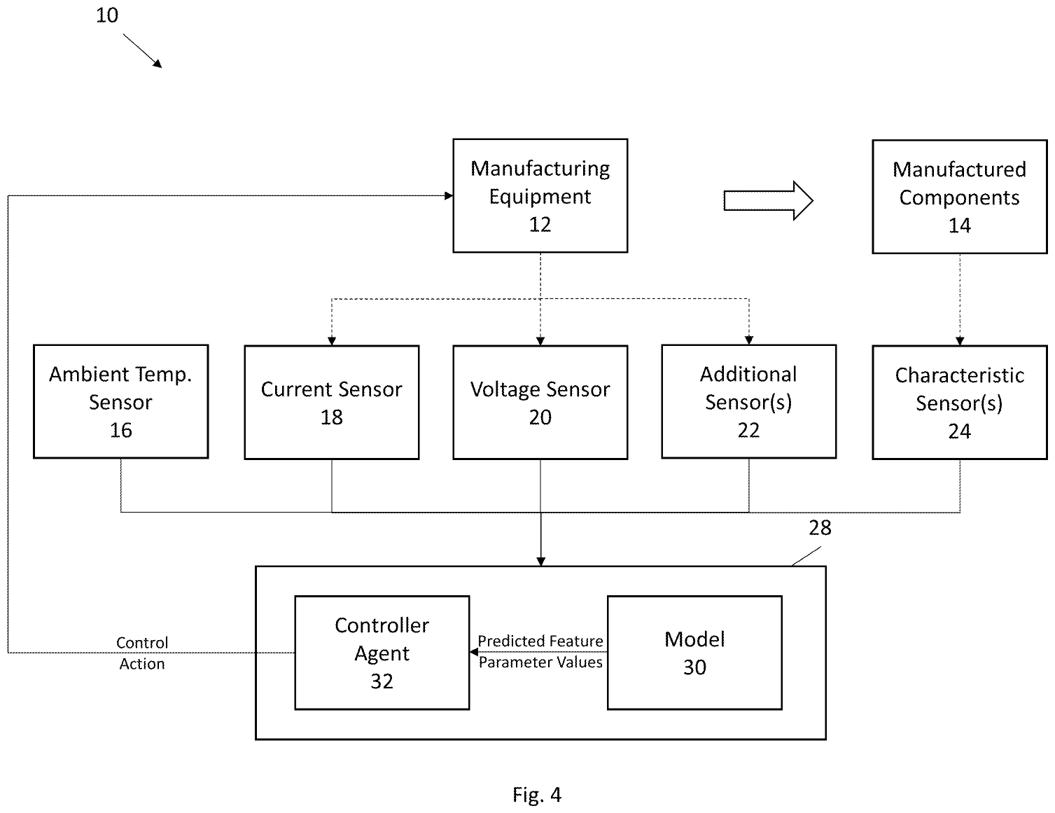

Referring to FIG. 4, once the controller agent 32 is adequately trained (e.g., the error between predicted and target feature parameter values is within some predetermined range), the one or more processors 28 may be arranged within the manufacturing system 10 such that they receive live data output by the sensors 16, 18, 20, 22, 24, and pre-process the data using the various transformations mentioned above to generate a live streaming feature seat spanning the relevant state space describing evolution of the manufacturing process associated with the manufacturing equipment 12. Similar to the above, the controller agent 32, now trained, may then direct control actions to the manufacturing equipment 12 to change control settings within their control limits to keep the predicted feature parameter values, and thus actual feature parameter values, at or near the target feature parameter values based on the live streaming feature set and the corresponding predicted feature parameter values. If, for example, the current pressure is 323 Pa and the specified range is 300 Pa to 325 Pa as described above, and the model 30 recognizes ambient and/or control parameter conditions indicating that pressure will rise at a rate of 1 Pa per second, the model 30 may provide predicted control parameter values to the controller agent 32 indicating that the pressure will exceed its upper limit within 3 seconds. Responsive to this data, the controller agent 32 may generate control actions for the manufacturing equipment 12 to begin to reduce the pressure before it exceeds its upper limit to maintain the pressure within its specified range.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words “controller” and “controllers,” for example, may be used interchangeably herein, as may the words “processor” and “processors.”

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A method comprising:
receiving at a machine learning model a training data set describing input parameters to and corresponding output parameters from manufacturing equipment;
training the machine learning model on the training data set using at least one learning algorithm to obtain a physics model that describes evolution of a state space of the manufacturing equipment;
configuring a machine-learning-based controller agent to generate commands for the physics model that modify settings of a simulation of the manufacturing equipment by the physics model such that, responsive to input data, the physics model generates corresponding predicted output parameters; and
training the machine-learning-based controller agent on the settings and corresponding predicted output parameters using at least one other learning algorithm such that, responsive to input data, the machine-learning-based controller agent maintains values of the predicted output parameters within respective predefined ranges.

2. The method of claim 1, further comprising configuring the machine-learning-based controller agent to generate commands for the manufacturing equipment responsive to values of predicted output parameters from the physics model such that the manufacturing equipment executes the commands.

3. The method of claim 2, further comprising configuring the machine-learning-based controller agent to generate the commands for the manufacturing equipment responsive to input parameters to and corresponding output parameters from the manufacturing equipment.

4. The method of claim 1 further comprising:
wherein the configuring includes receiving at the machine-learning-based controller agent one or more rules defining control actions for the manufacturing equipment to be taken responsive to a value of at least one output parameter from the manufacturing equipment being outside a predefined range.

5. The method of claim 4 further comprising:
receiving machine-learning-based controller agent time series data describing operating states of the manufacturing equipment; and
responsive to the operating states indicating the value of the at least one operating parameter is outside the predefined range, generating by the machine-learning-based controller agent a command for the manufacturing equipment to execute at least one of the control actions such that the manufacturing equipment performs the at least one of the control actions.

6. The method of claim 4, wherein the one or more rules are obtained from a rules controller.

7. The method of claim 4 further comprising receiving machine-learning-based controller agent input modifying the one or more rules in real time.

8. The method of claim 4, wherein the settings incorporate the rules.

9. The method of claim 1 further comprising operating the manufacturing equipment with a rules controller to generate the training data set.

10. The method of claim 1, wherein the input parameters include active control parameters, endogenous parameters, and exogenous parameters of the manufacturing equipment.

11. The method of claim 1, wherein the output parameters include feature parameters of components produced by the manufacturing equipment.

12. The method of claim 1, wherein the physics model is a sequence to sequence machine learning model.

13. The method of claim 12, wherein the sequence to sequence machine learning model is an encoder-decoder model.

14. The method of claim 13, wherein the encoder-decoder model includes long short-term memory models.

15. The method of claim 1, wherein the at least one learning algorithm is a supervised learning algorithm.

16. A method comprising:
training a machine learning model on a training data set, that describes input parameters to and corresponding output parameters from manufacturing equipment, using at least one learning algorithm to obtain a physics model that describes evolution of a state space of the manufacturing equipment;
configuring a machine-learning-based controller agent to generate commands for the physics model that modify settings of a simulation of the manufacturing equipment by the physics model such that, responsive to input data, the physics model generates corresponding predicted output parameters;
training the machine-learning-based controller agent on the settings and corresponding predicted output parameters using at least one other learning algorithm such that, responsive to input data, the machine-learning-based controller agent maintains values of the predicted output parameters within respective predefined ranges; and
configuring the machine-learning-based controller agent to generate commands for the manufacturing equipment responsive to values of predicted output parameters from the physics model such that the manufacturing equipment executes the commands.

17. The method of claim 16 further comprising:
wherein the configuring includes receiving at the machine-learning-based controller agent one or more rules defining control actions for the manufacturing equipment to be taken responsive to a value of at least one output parameter from the manufacturing equipment being outside a predefined range.

18. The method of claim 17 further comprising:
receiving machine-learning-based controller agent time series data describing operating states of the manufacturing equipment; and
responsive to the operating states indicating the value of the at least one operating parameter is outside the predefined range, generating by the machine-learning-based controller agent a command for the manufacturing equipment to execute at least one of the control actions such that the manufacturing equipment performs the at least one of the control actions.

19. The method of claim 17, wherein the one or more rules are obtained from a rules controller.

20. The method of claim 16 further comprising operating the manufacturing equipment with a rules controller to generate the training data set.
